(19) United States
(12) Patent Application Publication
(10) Pub. No.: US 2020/0322698 A1
(43) Pub. Date: Oct. 8, 2020

(54) SUPPORTING INTERACTIVE VIDEO ON NON-BROWSER-BASED DEVICES

(71) Applicant: Sony Interactive Entertainment LLC, San Mateo, CA (US)

(72) Inventors: Bhumik Sanghavi, Santa Clara, CA (US); Alex Hwang, Orinda, CA (US); Joel Freeman, San Rafel, CA (US)

(21) Appl. No.: 16/376,304

(22) Filed: Apr. 5, 2019

(51) Int. Cl. H04N 21/8545; H04N 21/81; H04N 21/44; H04N 21/433

(52) U.S. Cl. CPC H04N 21/8545; H04N 21/433; H04N 21/44008; H04N 21/8173

(57) ABSTRACT

A method, system and computer program product for enabling interactive video on non-browser based devices comprising receiving a media segment and analyzing the media segment for a link marker location having a corresponding network address. The link marker location is stored and sent to the client device. The client device sends the interface information, which is received and compared to the link marker location. A request is sent to a network address corresponding to link marker location when the interface information indicates an activation has occurred at the link marker location within the media segment during a presentation on the client device. The device at the network address sends resources, which are received over the network and converted into a resource media segment. The resource media segment is then sent to the client device.

### FIELD OF THE INVENTION

Aspects of the present disclosure are related to over-the-top streaming devices and more specifically aspects of the present disclosure are related to HTTP live streaming in Non-Browser based over-the-top boxes.

### BACKGROUND OF THE INVENTION

Many streaming media currently includes clickable links that lead to webpages on the internet. While many streaming media platforms, such as computers and video game consoles allow for links to outside websites from streaming media applications, many devices do not have this capability. Specifically many over-the-top (OTT) streaming devices do not have the capability to visit webpages linked from media streams. Currently, to provide this capability a user would need to purchase a new device.

Thus, there is a need in the art, to provide the capability for users to click on links and visit webpages from over-the-top streaming devices.

### BRIEF DESCRIPTION OF THE DRAWINGS

The teachings of the present disclosure can be readily understood by considering the following detailed description in conjunction with the accompanying drawings, in which:

FIG. 1 is a block diagram depicting the structure of a streaming system according to aspects of the present disclosure

FIG. 2 is a flow diagram showing a method for supporting interactive video on non-browser based devices according to aspects of the present disclosure.

FIG. 3 is a flow diagram depicting a method for view additional web resources on non-browser based devices according to aspects of the present disclosure.

FIG. 4 is a system diagram showing a standalone Reductive Edging device according to aspects of the present disclosure.

FIG. 5 is a system diagram depicting an embedded Reductive Edging system according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Media segments in HTTP Live streaming applications (HLS), often include meta-information about their content. This meta-information often includes links to websites on the internet. Many streaming devices include web browser stacks that allow the streaming device to access web pages on the internet. Many Over-the-Top (OTT) HLS streaming devices such as set top boxes connected to televisions do not have the capability to access web pages on the internet. According to aspects of the present disclosure reductive edging (RE) devices may provide OTT HLS streaming device that previously did not have the ability to view web pages, web page view capability.

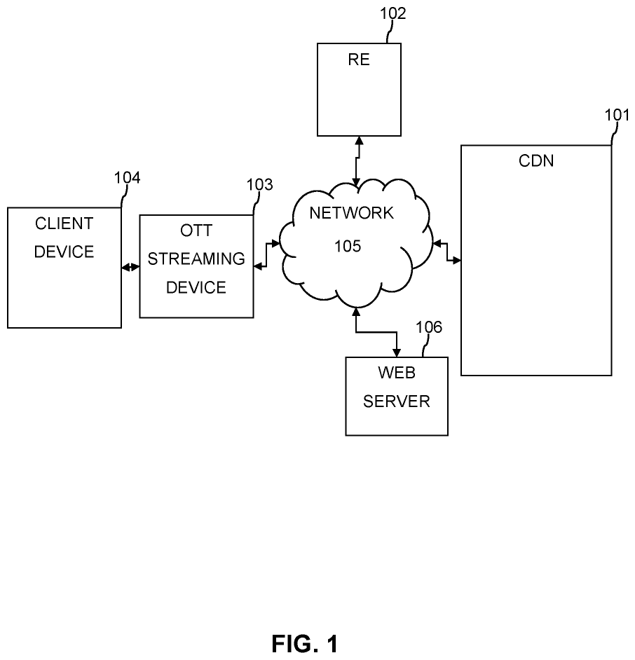

FIG. 1 depicts the structure of the HLS streaming system according to aspects of the present disclosure. A content delivery network (CDN) 101 may be configured to deliver media segments over a network 105 to a client device 104. The media segments may be provided to an Over-the-top (OTT) streaming device 103 to enable client devices such as Televisions and non-internet enable displays to stream network content. A reductive edger (RE) 102 device may be configured accelerate streaming start up and provide support for interactive content according to aspects of the present disclosure. Video start time reduction and the reductive edger device are further discussed in co-pending U.S. patent application Ser. No. 16/191,341 the contents of which are incorporated herein by reference.

The RE 102 prospectively downloads master playlists, media playlists from the CDN 101 through a network 105 before they are requested by the OTT streaming device 103. Upon receiving a request for a master playlist and a media playlist from the OTT streaming device 103, the RE 102 may prospectively begin downloading media segments from the CDN 101. According to aspects of the present disclosure, the RE 102 may decode and analyze each media segment for interactive content as will be discussed in the next section. After receiving a request for the media segment, the RE 102 may send the media segment to the OTT streaming device 103, which receives and decodes the media segment before placing it in a form suitable for display on the client device 104. A user may control the OTT streaming device 103 through a user interface. Typically a user interface input is used to control the content playback, content selection, embedded commerce activities, and the like. User interface information by way of example and not by way of limitation, may be a mouse cursor location, mouse cursor “click” location, touch screen button press location, or the like may be sent to the RE 102. The RE 102 may analyze user interface information and compare the user interface information to the location of interactive content in the media segment.

According to aspects of the present disclosure, if the user interface information indicates that the user clicked on an interactive link in the media segment, the RE 102 will send a request to an address corresponding the address of a webserver 106 specified by the interactive content. In response the webserver 106 may send resources back to the RE 102. The RE 102 receives the resources and converts the resources to a media segment before sending it to the OTT 103. Resources as used herein may be webpages, or webpage content such as HTML code, images, sounds, videos, etc. By way of example, and not by way of limitation, in some implementations, this method may be used to play embedded videos. With a middleware-like RE, any content could be converted to a media (e.g., video) segment, or segments. Furthermore, where convenient, RE 102 could convert images or text could into one or more media segments.

The OTT streaming device 103 may be, for example and without limitation, an AppleTV device, a Roku streaming media device, a smart TV streaming device or similar device.

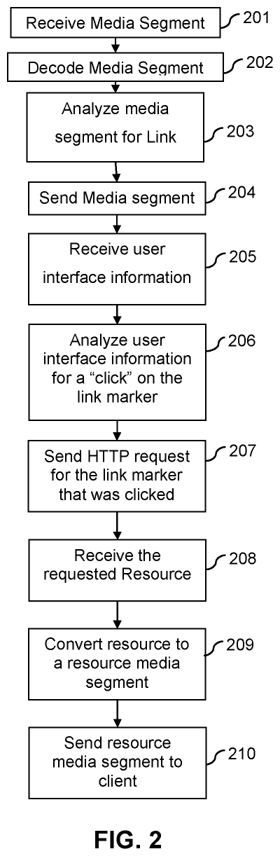

FIG. 2 depicts the method enabling web content on over-the-top streaming devices according to aspects of the present disclosure. The RE receives a media segment from the CDN or other media server, as indicated at 201. The RE stores the media segment in a memory. As part of the streaming protocol, the media segment may be encoded in a streaming format such as MPEG-2, MPEG-4, AAC or similar.

The RE may decode the media segment at 202 before analyzing the media segment for a link marker, as indicated at 203. A link marker may be metadata in the media segment linking to webpage; this metadata may be in the form of an ID3 or ID3v2 tag. For video segments the horizontal and vertical position of the link marker within the video frame. This information about the location and address of the link marker is stored in the memory of the RE. Depending on how the link information is packaged into the stream it may be necessary to decode a segment in order to read the link marker. For ID3, the link marker could be muxed in as a separate ‘stream’ from the video or audio streams. In this case, the container of the media segment would need to be decrypted (if encryption is used) and demuxed to extract the stream containing ID3. Alternatively, if ID3 is actually encoded into the video stream then the video stream needs at least be parsed to extract the metadata. Aspects of the present disclosure are not limited to such implementations. Those skilled in the art will be able to device other ways to embed metadata such as ID3 tags without decryption or decoding depending on the content packaging process design.

In response to a request for the media segment, the RE sends the media segment to the requesting device, as indicated at 204. The requesting device may then provide user interface information back to the RE, as indicated at 205. The premise here is that to provide certain user interactivity (e.g., other than traditional playback controls) the client device needs a middleware-like RE to process an ad hoc user request. Therefore, a client device must relay a request from the end user to the RE to provide the proper response. The RE then analyzes the user interface information to determine whether the user has activated a link, as indicated at 206. In some embodiments the RE may compare the screen coordinates of the link marker determined at 203 with the user interface information and if the user interface information indicates a cursor click, button press, or some other activation event in the screen coordinates of the link marker then the system will deem the link to be activated. Aspects of the present disclosure include implementations in which the client device determines whether a link has been activated. However, an advantage of reductive edging, is that it can relieve or reduce a client device's responsibility to do this kind of processing.

Once a link marker has been deemed activated, the RE sends a web request to the network address indicated by the link marker, as indicated at 207. The web request may, by way of example and not by way of limitation, be a request for a resource or resources using Uniform resource locator (URL) and a hypertext transfer protocol (HTTP).

In response to the request sent by the RE, the web server or other network device may send a resource or resources to the RE. The RE receives and stores the resource or resources, as indicated at 208. The RE then may convert the resource into a media segment that is compatible with the OTT device and the client device, as indicated at 209.

By way of example and not by way of limitation the RE may convert the resources received from the web server or other network device into a video frame or picture. The RE may then encode the video frame picture in a coding standard compatible with the OTT device (e.g. MPEG-2 or MPEG-4). Additionally, sound resources may be converted into file types compatible with the OTT and client devices. The converted media segments may then be sent to the OTT device. Sending media segments that are part of the media playlist may be postponed while sending converted media segments to the OTT device .

Webpages that converted to media segments are not initially part of a playlist. There are a number of ways in which such ad hoc content could be injected into a playlist. A dynamic or live playlist is constantly being refreshed and during a refresh the ad hoc content could be injected. With recorded content where a playlist is typically not refreshed, client needs to switch to a new playlist provided by RE. To covert a web page to media segments, a web page could be treated as an image or a frame by specifying a very low frame rate, e.g., 1/300 frames per second (FPS), i.e., 1 frame per 300 seconds. If the client device has problems handling very low frame rates the encoder could just repeat the frame. For web pages that are lager than a single screen, the encoding process can resize the frame. Animated web pages can just be encoded at an appropriate FPS.

By way of example, and not by way of limitation, web pages could be rendered in a browser engine on the RE device. The browser can re-render every time there is an update to the webpage which can be 60 times a second, or 60 frames per second. RE could take these frames and encode them into video segments. All animation and navigating pages in the website etc. could be handled in the browser engine. Examples of suitable browser engines include WebKit, an open source originally authored by KDE.

The resource converted media segments sent to the OTT device, as indicated at 210 are subsequently decoded and delivered to the client device where the converted media segments are displayed to the user.

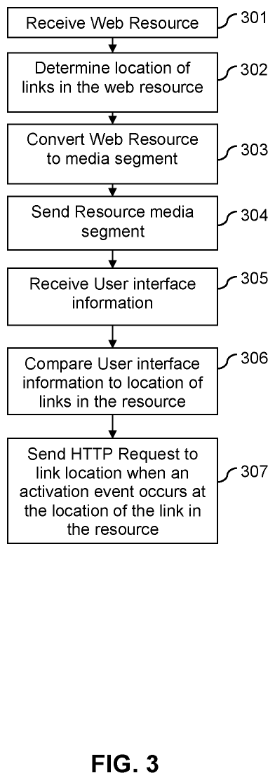

In some embodiments, the RE may analyze the resources for other media links as shown in FIG. 3. Web resources received by the RE, as indicated at 301 may be analyzed to determine the location of link within the resource, as indicated at 302. The URL of each link in the resource may also be determined and recorded. Subsequently the web resource may be converted to a resource media segment, as indicated at 303 and sent to the OTT or client device, as indicated at 304. The OTT or client device may send the user interface information to the RE, as indicated at 305. The RE compares the user interface information with the location of the link within the resource at 306 and when an activation is detected at the screen location of the link the RE may send a request to the network address specified by the link, as indicated at 307. In this way internet, browsing capability may be provided to over the top devices that do not possess such capabilities.

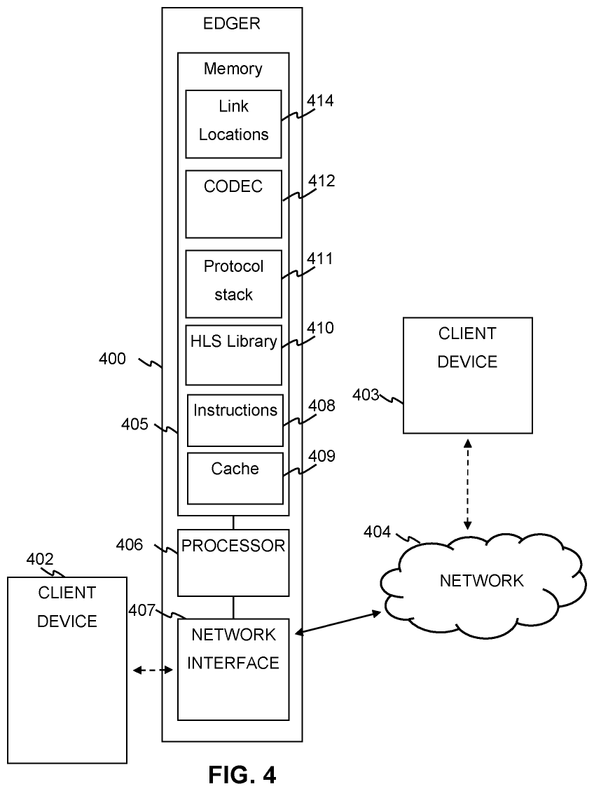

FIG. 4 shows a standalone Reductive Edging device according to aspects of the present disclosure. The standalone Reductive Edging device or Edger 400 may be coupled to a local OTT device or client device 402 through a network interface 407 over a LAN or WAN. If the Reductive Edger 400 is on the same device as the client, it can use a loopback network interface which is very high speed. In other alternative implementation the standalone Reductive Edging device may be in communication through the network interface 407 with a non-local device 403 e.g., servers or another client, through a large network 404 such as the internet. In some implementations the client device is connected to the stand alone Reductive Edging device through a communication bus (not shown) such as, without limitation, a peripheral interconnect (PCI) bus, PCI express bus, Universal Serial Bus (USB), Ethernet port, Fire-wire connector or similar interface.

The standalone Reductive Edging device 400 may include one or more processor units 406, which may be configured according to well-known architectures, such as, e.g., single-core, dual-core, quad-core, multi-core, processor-coprocessor, cell processor, and the like. The standalone Reductive Edging device 400 may also include one or more memory units 405 (e.g., random access memory (RAM), dynamic random access memory (DRAM), read-only memory (ROM), and the like).

The processor unit 406 may execute one or more instructions 408, portions of which may be stored in the memory 405 and the processor 406 may be operatively coupled to the memory through a bus or bus type connection. The instructions 408 may be configured to implement the method for Implementing Interactive Video in Non-browser based streaming systems shown in FIG. 2 and FIG. 3 as well as instructions for segmenting playlists and media segments. Additionally the Memory 405 may contain instructions for storing Playlists and Link locations and a Protocol Stack defining HLS server locations. The Memory 405 may also contain the HLS Library 410, the link locations 414, the Protocol Stack 411, and a coder/decoder (codec) 412. As used, herein, the term “protocol stack” or network stack refers to an implementation of a computer networking protocol suite or protocol family. In general terms, a protocol suite is a definition of a communication protocol, and a protocol stack is the software implementation of the protocol suite. Individual protocols within a suite are often designed as software modules, each having a single purpose in mind to facilitate design and evaluation. Because each protocol module usually communicates with two others, they are commonly imagined as layers in a stack of protocols. The lowest level protocol deals with low-level interaction with the communications hardware. Higher layers add more features and capability. User applications usually deal only with the topmost layers.

By way of example, and not by way of limitation, the protocol stack 411 may include the following protocols at the following layers: Hyper Text Transfer Protocol (HTTP) at the Application layer; Transfer Control Protocol (TCP) at the Transport layer; Internet Protocol (IP) at the Internet/Network Layer; Ethernet at the Data Link/Link layer; and IEEE 802.3u at the Physical layer.

The instructions 408 may further implement analyzing link locations within web resources and storing the URL of the links and location of the links within the converted video frame 414. The Cache 409 may also be located in memory 405.

The standalone Reductive Edging device 400 may include a network interface 407 to facilitate communication via an electronic communications network 404. The network interface 407 may be configured to implement wired or wireless communication over local area networks and wide area networks such as the Internet. The device 400 may send and receive data and/or requests for files via one or more message packets over the network 404. Message packets sent over the network 404 may temporarily be stored in a cache 409 in memory 405. The client device 402 may connect through the network interface 307 to the electronic communications network 404. Alternatively, the client device 403 may be in communication with the standalone Reductive Edging device 400 over the electronic communication network 304.

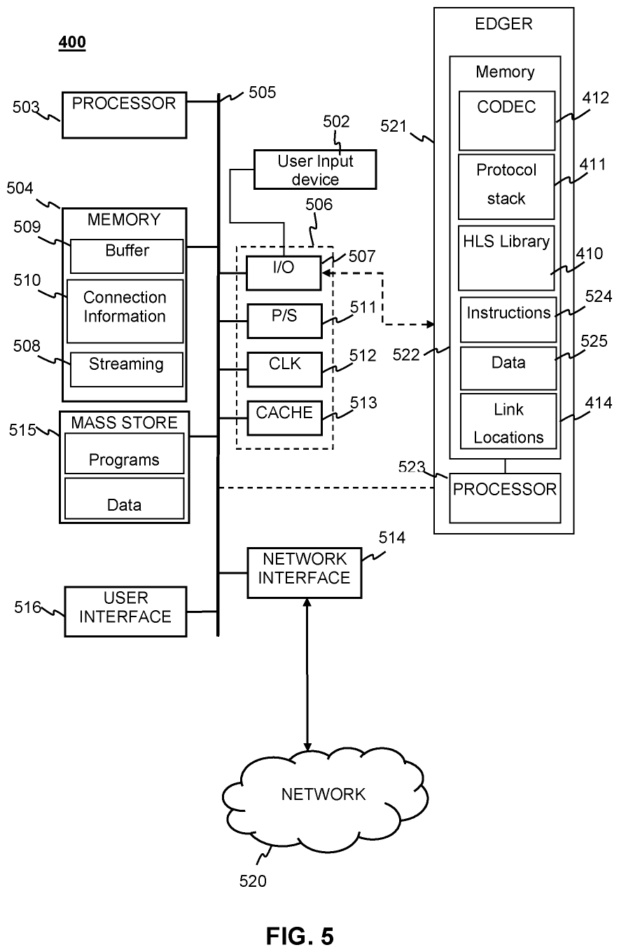

FIG. 5 depicts an embedded Reductive Edging system according to aspects of the present disclosure. The embedded Reductive Edging system may may be embedded into a CDN server, a OTT client device 500 (e.g., a television) coupled to a user's input device 502. The user's input device 502 may be a controller, touch screen, microphone, keyboard, mouse, joystick or other device that allows the user to input information including sound data in to the system. In generally, the embedded Reductive Edging device could be embedded anywhere that could reach the content and be reached by the target client or clients.

The computing device of the embedded Reductive Edging system 500 may include one or more processor units 503, which may be configured according to well-known architectures, such as, e.g., single-core, dual-core, quad-core, multi-core, processor-coprocessor, cell processor, and the like. The computing device may also include one or more memory units 504 (e.g., random access memory (RAM), dynamic random access memory (DRAM), read-only memory (ROM), and the like).

The processor unit 503 may execute one or more programs, portions of which may be stored in the memory 504 and the processor 503 may be operatively coupled to the memory, e.g., by accessing the memory via a data bus 505. The programs may be configured to implement streaming media through HLS systems 508. Additionally the Memory 504 may contain information about connections between the system and one or more streaming servers 510. The Memory 504 may also contain a buffer of media segments 509. The Media segments and connection information may also be stored as data 518 in the Mass Store 518.

The computing device 500 may also include well-known support circuits, such as input/output (I/O) 507, circuits, power supplies (P/S) 511, a clock (CLK) 512, and cache 513, which may communicate with other components of the system, e.g., via the bus 505. . The computing device may include a network interface 514. The processor unit 503 and network interface 514 may be configured to implement a local area network (LAN) or personal area network (PAN), via a suitable network protocol, e.g., Bluetooth, for a PAN. The computing device may optionally include a mass storage device 515 such as a disk drive, CD-ROM drive, tape drive, flash memory, or the like, and the mass storage device may store programs and/or data. The computing device may also include a user interface 516 to facilitate interaction between the system and a user. The user interface may include a monitor, Television screen, speakers, headphones or other devices that communicate information to the user.

The computing device 500 may include a network interface 514 to facilitate communication via an electronic communications network 520. The network interface 514 may be configured to implement wired or wireless communication over local area networks and wide area networks such as the Internet. The device 500 may send and receive data and/or requests for files via one or more message packets over the network 520. Message packets sent over the network 520 may temporarily be stored in a buffer 509 in memory 504.

In some implementations, the embedded Reductive Edging or embedded Edger 521 may be an embedded hardware component of a CDN, an origin server device or production device, which may be coupled to the main processor via the bus and requests may be received from applications, e.g., streaming applications, running on the client device. As used herein, the term “production device” refers to a device that processes captured content and transmits the content to one or more service providers. In some implementations, the embedded Edger 521 may initiate and intercept network communications directed toward a CDN or other servers. In these implementations, the embedded Edger 521 may lack a network interface or the network interface may not be used. In other implementations, the embedded Edger, the functions of the edger may be implemented in streaming software 508 stored in the memory 504 or in programs 517 stored in the mass store 515 and executed on the processor 503.

In some alternative implementation the embedded Edger 521 may be an external device coupled to the client device 500, e.g., via a local non-network connection, such as the I/O functions 507.

The processor of the embedded Edger unit 521 may execute one or more instructions 524, portions of which may be stored in the edger memory 522 and the processor 523 may be operatively coupled to the memory 522 through a bus or bus type connection. The instructions 524 may be configured to implement the method for implementing interactive video in non-browser based streaming systems shown in FIG. 2 and FIG. 3. Additionally the Memory 522 may contain instructions for storing Playlists and a Protocol Stack defining HLS server locations. The Memory 522 may also contain the HLS Library 410, the Protocol Stack 411, the Link Locations 414 and a coder/decoder (codec) 412. The instructions 424 may further implement storage of media segments as data 425 during operation. The instructions 524 may further implement analyzing link locations within web resources and storing the URL of the links and location of the links within the converted video frame 414. Alternatively the HLS Library, Protocol stack and media segments may be stored on the client device 500 in the buffer 508 or as connection information 508 in memory 504 or as data 518 in the Mass Store 515.

In the interest of clarity, not all of the routine features of the implementations described herein are shown and described. It will be understood by those skilled in the art that in the development of any such implementations, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of the present disclosure.

In accordance with aspects of the present disclosure, the components, process steps, and/or data structures may be implemented using various types of operating systems; computing platforms; user interfaces/displays, including personal or laptop computers, video game consoles, PDAs and other handheld devices, such as cellular telephones, tablet computers, portable gaming devices; and/or general purpose machines. In addition, those of ordinary skill in the art will recognize that devices of a less general purpose nature, such as hardwired devices, field programmable gate arrays (FOGs), application specific integrated circuits (ASICs), or the like, may also be used without departing from the scope and spirit of the inventive concepts disclosed herein.

While the above is a complete description of the preferred embodiments of the present invention, it is possible to use various alternatives, modifications, and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35 USC § 112, ¶ 6.

What is claimed is:

1. A method for enabling web content on over-the-top streaming platforms comprising:
a) receiving a media segment;
b) analyzing the media segment for a link marker location having a corresponding network address;
c) storing the link marker location;
d) sending the media segment to a client device;
e) receiving interface information from the client device;
f) comparing interface information to the link marker location;
g) sending a request to a network address corresponding to the link marker location when the interface information indicates an activation has occurred at the link marker location within the media segment during a presentation on the client device;
h) receiving a communication from the network address;
i) converting the communication into a converted media segment;
j) sending the converted media segment to the client device.

2. The method of claim 1, wherein analyzing the media segment for a link marker location further comprises decoding the media segment.

3. The method of claim 1, wherein analyzing the media segment for a link marker location within the media segment further comprises determining a screen coordinate within the media segment of the link marker.

4. The method of claim 1, wherein the link marker is an ID3 tag.

5. The method of claim 1, wherein the interface information is a location of a cursor and wherein an activation is a cursor click.

6. The method of claim 5, wherein comparing the interface information to the link marker location further comprises determining whether the cursor was clicked at the link marker location within the video segment.

7. The method of claim 1, wherein the communication from the network address is a webpage.

8. The method of claim 7, wherein converting the communication to a converted media segment includes converting the webpage in to a video file.

9. The method of claim 1, further comprising analyzing communication for link marker locations and repeating steps e) through j).

10. A system for enabling web content on over-the-top streaming platforms comprising;
a processor;
memory coupled to the processor;
non-transitory instruction embedded in the memory that when executed cause the processor to enact the method comprising;
a) receiving a media segment;
b) analyzing the media segment for a link marker location having a corresponding network address;
c) storing the link marker location;
d) sending the media segment to a client device;
e) receiving interface information from a client device;
f) comparing the interface information to the network address corresponding to the link marker location;
g) sending request to the network address corresponding to link marker location when the interface information indicates an activation has occurred at the link marker location within the media segment during a presentation on the client device;
h) receiving a communication from the network address;
i) converting the communication in to a converted media segment;
j) sending the converted media segment to the client device.

11. The system of claim 10, wherein analyzing the media segment for a link marker location further comprises decoding the media segment.

12. The system of claim 10, wherein analyzing the media segment for a link marker location within the media segment further comprises determining a screen coordinate within the media segment of the link marker.

13. The system of claim 10, wherein the link marker is an ID3 tag.

14. The system of claim 10, wherein the interface information is a location of a cursor and wherein an activation is a cursor click.

15. The system of claim 14, wherein comparing the interface information to the link marker location further comprises determining whether the cursor was clicked at the link marker location within the video segment.

16. The system of claim 10, wherein the communication is a webpage.

17. The system of claim 16, wherein converting the communication to a converted media segment includes converting the webpage in to a video file.

18. The system of claim 10, further comprising analyzing communication for link marker locations and repeating steps e) through j).

19. Non-transitory instructions embedded in a computer readable medium that when executed cause a computer to enact the method comprising:
a) receiving a media segment;
b) analyzing the media segment for a link marker location having a corresponding network address;
c) storing the link marker location;
d) sending the media segment to a client device;
e) receiving interface information from the client device;
f) comparing interface information to the link marker location;
g) sending request to the network address corresponding to the link marker location when the interface information indicates an activation has occurred at the link marker location within the media segment during a presentation on the client device;
h) receiving a communication from the network address;
i) converting the communication in to a converted media segment;
j) sending the converted media segment to the client device

20. The non-transitory instructions of claim 19, further comprising analyzing communication for link marker locations and repeating steps e) through j).
